(19) United States
(12) Patent Application Publication
(10) Pub. No.: US 2023/0316362 A1
(43) Pub. Date: Oct. 5, 2023

(54) E-COMMERCE PLATFORM, SYSTEMS AND METHODS FOR THE SELLING OF GOODS AND SERVICES THROUGH MADE-TO-ORDER PRODUCTS GENERATED BY THREE-DIMENSIONAL MODELS

(71) Applicant: Saw and Sew Ltd., London (GB)

(72) Inventor: James Winston Richard Ferguson, Krakow (PL)

(21) Appl. No.: 18/131,142

(22) Filed: Apr. 5, 2023

Related U.S. Application Data
(60) Provisional application No. 63/327,621, filed on Apr. 5, 2022.

(51) Int. Cl. G06Q 30/0601; G06Q 30/0201; G06F 30/12

(52) U.S. Cl. CPC G06Q 30/0621; G06Q 30/0643; G06Q 30/0206; G06F 30/12; G06F 2111/16

(57) ABSTRACT

A method for selling customized goods and/or services, comprising: receiving user input for a desired type of good and/or service to be customized; accessing a first database to retrieve a 3D CAD model of the desired type, the database also providing a list of attributes of the desired type, the attributes being usable in the construction of a finished good and/or service; selecting one or more attributes from the list of attributes; accessing a second database to retrieve goods and/or services of the desired type having one or more selected attributes; loading hidden instance of 3D CAD models with goods and/or services as inputs; mapping goods and/or services to product inputs; generating instances of a customized product and 3D images of the product being customized having the selected attributes; and presenting a generated 3D depiction of a customized good and/or service selected in conformity with the selected attributes thereof.

### CROSS-REFERENCE TO RELATED APPLICATION

This application is a non-provisional application claiming priority from provisional application 63/327,621 filed Apr. 5, 2022, which application is incorporated herein by reference.

### BACKGROUND OF THE INVENTION

### 1. Field of the Invention

The present invention is directed to the e-commerce industry, more specifically, to systems and methods for the selling of goods and services through made-to-order products generated by three-dimensional models.

### 2. Description of the Related Art

When consumers shop for items, such as durable goods, they often find that the options available for purchase do not completely satisfy their needs or desires. For example, some items available in the marketplace may lack one or more desired features, while having additional features that do not matter to that particular consumer. Therefore, it would be advantageous to consumers to permit the personalization of durable goods items to more closely match their desired combination of features, and many customers would benefit from having the ability to extend their product choices and bring what they buy closer to what they want. Unfortunately, sales, distribution, and manufacturing systems meant to bring mass-manufactured items to consumers and/or job-shops that conduct custom manufacturing are not positioned to efficiently offer mass-customization, thus excluding customers from custom-designed products. Furthermore, the equipment, techniques, and people are inefficient at providing cost-effective customization. With the use of 3D modelling software that runs on a computer, both professionals and non-professionals in a number of different disciplines may create three-dimensional (3D) models of items such as buildings, cars, and other objects. Input devices such as a keyboard, mouse, trackball, and/or stylus are used to interface with 3D modelling software. The drafting document is presented on a visual display device, such as a computer monitor or screen.

Overall, a user may design numerous three-dimensional shapes (directly or by defining 2D faces that make up 3D shapes), add colors and/or textures, move, scale, rotate, skew and resize the shapes using 3D modelling software in most cases. This type of program offers users a variety of stock objects (such as 3D forms such as spheres) and/or tools to build such things (such as arcs, circles, and rectangles), depending on the software. The program allows users to store models in a preset format. It is now possible for customers to make changes to items in a variety of ways using computer-based networks, access systems, websites, databases and 3D geometry manipulation. As a result, consumers can now realistically participate in at least some aspects of a design process, such as those that do not pose a risk to a customer or create liability for the manufacturer, as defined by constraints that prevent a customer from violating the constraints during design for personalization or customization.

Metadata systems are used to access structured information databases. Unstructured data can be found on the Internet, in Web papers and sites, as well as in image, sound, or video files. Until recently, unstructured files frequently lacked a consistent system of indexing or classification. Instead, information extraction technologies such as natural language processing (NLP) “seek” the content or rate items based on relevance using algorithms, word placement, and occurrence. The current deployment techniques for both CAD/CAM systems and additive manufacturing technologies are limiting their wider adoption. Throughput, for example, prevents a machine from producing more than a modest number of goods in an acceptable amount of time. The effective capacity would be considerably improved if machines in one place were connected to machines in several dispersed locations. As a result of these variations, all of the different additive fabrication methods may be necessary to produce a completed product that meets the requirements for a certain item. Because it is impractical for any single facility to own every machine of every type from every manufacturer, it is desirable to link many facilities together, allowing additive fabrications to reach their full potential. Currently, there are more than twenty-five methods of additive manufacturing that are protected by various patents. There are advantages and disadvantages to each of these technologies, including the feature resolution, materials that the technique can utilize and the speed, surface quality, and many other criteria by which a component may be assessed.

These and many other problems have been long identified. Different solutions to the problems have been tried. However there exists no comprehensive solution to all the above problems.

### SUMMARY OF THE INVENTION

It is an object of the invention to provide an improved system and method for the selling of goods and services through made-to-order products generated by three-dimensional models.

The present invention addresses an array of problems in the field, some of which are described below. Specifically, the disclosed invention provides systems and methods that enable users to design, sell and produce products with nearly infinite seller variations subject to infinite customer customizations and further assist users in the production of products in the location closest to the customer.

It is therefore an object of the present invention to provide a product metadata tag system that assists users in classifying products and also in designing objects, goods, products, services, texts and images. Additionally, the inventive product metadata tag system is expected to assist users in tagging names and tag types related to how a consumer searches for products; tag types are based on product features or categories that can have infinite tag names and infinite tag types but, each tag name must have at least one associated tag type.

Yet another object of the present invention is to provide a 3D Model Metadata System that assists users in storing data related to 3D models that are applicable to design objects, goods, products, and services.

It is a further object of the present invention to provide an Image Metadata Tag System that assists users in classifying images wherein specific classifications are used in specific places and can have infinite tag names, but each tag must belong to a tag type.

A still further object of the present invention is to provide a System for Creating Products that assists users in creating a 3D model where its initial 3D model metadata is defined and product category metadata tags for 3D model are defined.

A still further object of the present invention is to provide a System for Producing Products that provides product 3D model state metadata prepared according to 3D model parameter metadata for goods and services and generate product images based thereon.

Yet another object of the present invention is to provide systems for product display, product pricing, texts used for application and to manage location analytics data.

A further object of the present invention is to provide methods to retrieve products based on location, generate products based on user selected metadata, display set numbers of products, generate product images and pricing products.

Therefore, the present invention overcomes the limitations and drawbacks from the prior art. To achieve the above and other objects, the present invention anticipates new and entirely different systems and methods that resolve the limitations and drawbacks of the prior art.

In light of the preceding background, embodiments of the present invention provide systems and methods for the selling of goods and services through made-to-order products generated by three-dimensional models. The inventive systems and methods enable users to design, sell and produce products with nearly infinite seller variations subject to nearly infinite customer customizations and production of products in the location closest to the customer. Specifically, the systems disclosed in accordance with one or more embodiments of the present invention are directed towards product metadata tagging, 3D model metadata, image metadata tagging, product creation, product production, product display, product pricing, texts used for application and location analytics data. Additionally, the further embodiments of the present invention disclose methods for the selling of goods and services through made-to-order products generated by three-dimensional models that include methods to retrieve products based on location, methods to generate products based on user selected metadata, methods to display set number of products, methods to generate product images and methods for pricing products.

Other objects and features of the present invention will become apparent from the following detailed description of the presently preferred embodiments, considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Aspects of the disclosure may be implemented in certain parts, steps, and embodiments that will be described in detail in the following description and illustrated in the accompanying drawings in which like reference numerals indicate similar elements. It will be appreciated with the benefit of this disclosure that the steps illustrated in the accompanying figures may be performed in other than the recited order and that one or more of the steps disclosed may be optional. It will also be appreciated with the benefit of this disclosure that one or more components illustrated in the accompanying figures may be positioned in other than the disclosed arrangement and that one or more of the components illustrated may be optional. The prior and other objects of this invention, the various features thereof, as well as the invention itself, may be more fully understood from the following description, when read together with the accompanying drawings in which:

FIG. 1 is a stylized depiction of a product metadata tag system according to the invention;

FIG. 2 is a stylized depiction of a 3D model metadata system according to the invention;

FIG. 3 is a stylized depiction of an image metadata tag system according to the invention;

FIG. 4 is a stylized depiction of a system for creating products according to the invention;

FIG. 5 is a stylized depiction of a system for producing products according to the invention;

FIG. 6 is a stylized depiction of a flow chart for system for displaying products according to an embodiment of the invention;

FIG. 7 is a stylized depiction of a system for product pricing according to the invention;

FIG. 8 is a stylized depiction of a text system according to the invention;

FIG. 9 is a stylized depiction of a location analytics data system according to the invention;

FIG. 10 is a flow diagram illustrating a method for retrieval of products based on location according to the invention;

FIG. 11 is a flow diagram illustrating a method to generate products based on user selected metadata according to the invention;

FIG. 12 is a flow diagram illustrating a method to display set numbers of products according to the invention;

FIG. 13 is a flow diagram illustrating a method to generate product images according to the invention;

FIG. 14 is a flow diagram illustrating a method for pricing products according to the invention;

FIG. 15 depicts a product listing page according to the invention;

FIG. 16A depicts an individual product page according to the invention; and

FIG. 16B depicts an individual product page with an overlay showing selected rich text content according to the invention.

### DETAILED DESCRIPTION OF THE PRESENTLY PREFERRED EMBODIMENTS

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to is/are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, embodiments of the invention can include a variety of combinations and/or integrations of the other embodiments described herein.

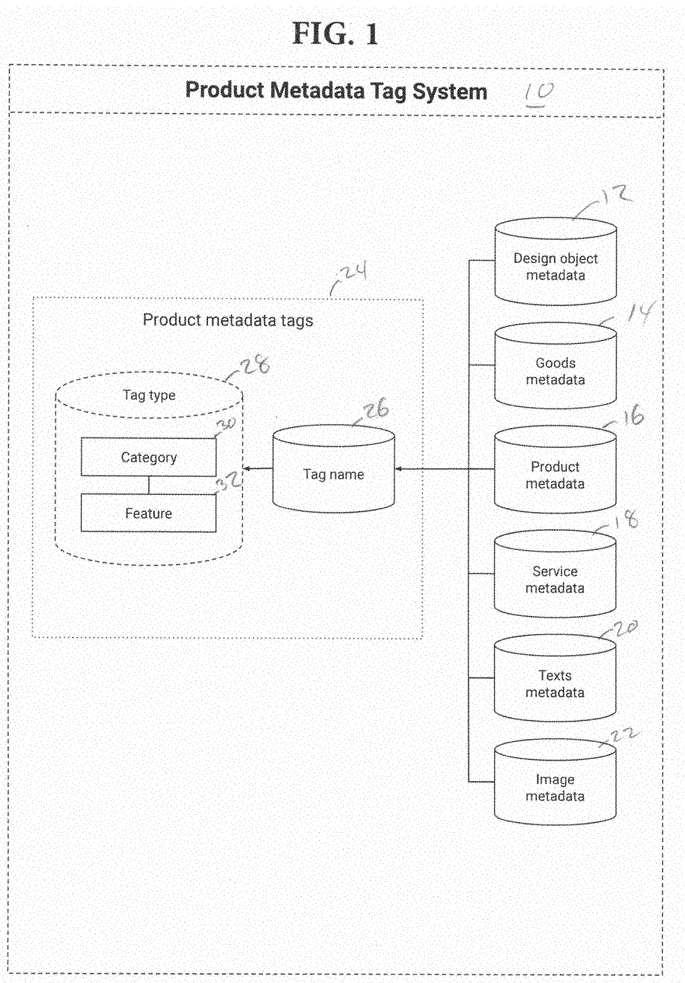

Turning to the figures and specifically to FIG. 1, one embodiment of the present invention is directed to a product metadata tag system 10, wherein the system comprises design object metadata 12, goods metadata 14, product metadata 16, service metadata 18, texts metadata 20 and image metadata 22.

Design objects metadata 12 might include a record of the name and base price of an object or product, as well as data related to the Product Metadata System 16, such as the category of the product and its features. Data related to a 3D Model Metadata System, such as optional specifications of data to create products based on marketing objectives, may likewise be included. These records may include associations with Image Database Records, such as images specific to a design object, as well as associations with Texts Database Records, such as specific texts for design object, with 3D Model Database Record, such as 3D model design the object relies on and/or with Good/Services Database Records, such as the goods/services used in the design object.

Goods metadata 14 would include identifiers (name, SKU) of a good itself and variants of itself (colors, sizes, etc.) and prices. Goods metadata 14 would also be associated with information about the supplier of the goods, as well as images of and relating to the good and textual information about the good.

Product metadata 16 would include information related to the product, such as the category and features thereof. More specifically, it would include product metadata tags 24, which, in turn, include both tag names 26 and tag types 28. Tag types 28 include both categories 30 and features 32. Product metadata 16 would also include information such as the price of the product and reference to its parent design object. Product metadata 16 would also include data related to state data to create the product in a 3D model. Furthermore, product metadata 16 could include associations with Image Database Records containing images specific to the and product Text Database Records containing specific text for the product, such as descriptions and background information.

Image Metadata 22 would include specification of studio and texture image types specific to each individual good/service.

Product metadata tag system 10 may be used to classify products and to design objects, goods, products, services, texts and images, wherein tag types 28 are based on product categories 30 and/or features 32. Additionally, tag names 26 and tag types 28 of product metadata tag system 10 are related to how a consumer searches for products and are capable of having nearly infinite tag names 26 and infinite tag types 28, wherein each tag name 26 must have at least one associated tag type 28.

When System 10 is in operation, a user creates a tag name 26 and specifies associated category(ies) 30 and/or feature(s) 32 before the information is stored in the database. The storage of this information may be done in a single table or several tables to accommodate more complex relationships between names, categories, and type. When the application retrieves records based on a tag, it does so using server-side scripts.

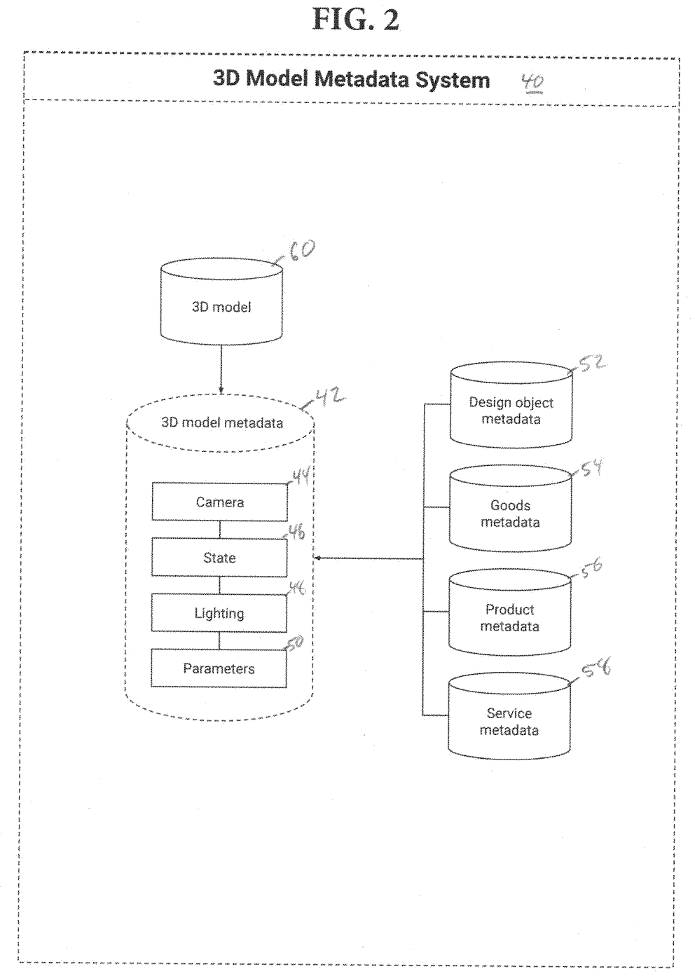

Now referring to FIG. 2, another embodiment of the present invention is directed to a 3D model metadata system 40. With respect to the invention, the term “3D model metadata” would include reference to a design's 3D geometry and the Computer Aided Design (CAD) technology(ies) used to show the 3D model on a user device. It would also include data related to: product categories in Product Metadata System 16 and, in a 3D Model Metadata System 40, camera, lighting, parameter, and state data needed to initiate 3D model.

Accordingly, 3D model metadata system 40 includes 3D model metadata 42 such as camera metadata 44, metadata related to the specific state of a model 46, lighting metadata 48 and parameter metadata 50. Specifically, 3D model metadata system 40 may further include design object metadata 52, goods metadata 54, product metadata 56 and/or service metadata 58. Based on this metadata 52, 54, 56 and/or 58, 3D model metadata system 40 may be used to design objects, goods, products, and/or services and particularly used to store data related to 3D models 60. Additionally, every 3D model has a default camera, lighting, parameter, and state metadata. Design objects supplement or override this data and have a default state metadata wherein products are a design object in a specific state and goods and services supplement this data to accommodate themselves.

As 3D models are initiated through client side scripts, the back end of the application focuses on efficient querying of records required by client side scripts. 3D model metadata type records contain a JSON (JavaScript Object Notation) data column but may also include additional columns (such as a string, integer, Boolean) to facilitate back end requirements. These metadata records may use specific columns in a table or separate tables depending on the required flexibility or efficiency in querying.

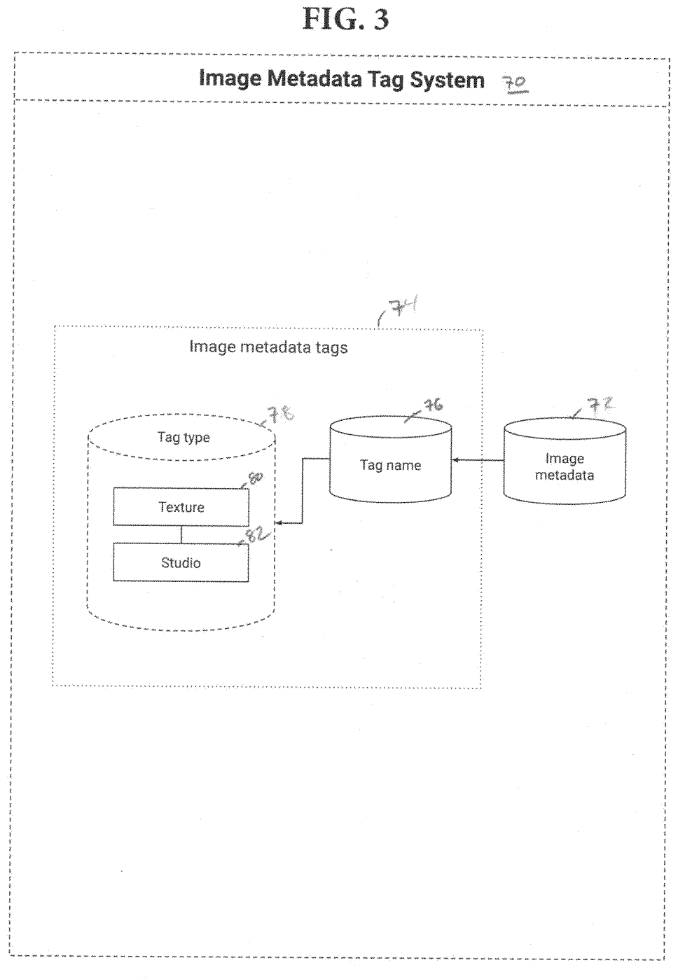

Similarly, FIG. 3 illustrates the elements and workflow of an image metadata tag system 70 in accordance with the invention, wherein image metadata tag system 70 includes image metadata 72 and image metadata tags 74 that are further classified by tag names 76 and tag types 78. Tag types 78 include texture tag types 80 and studio tag types 82 and image metadata tag system 70 classifies images wherein specific classifications are used in specific places and image metadata tag system 70 is capable of utilizing substantially infinite tag names 76 however, each tag must belong to a tag type 78.

Tag names 76 and associated texture tag types 80 or studio tag types 82 are stored as strings in the database.

Texture tag types 80 facilitate the use of images as textures in 3D models. This mostly relates to goods used as parameters in 3D models.

Studio tag types 82 facilitate the retrieval of images in the shop page and as image placeholders to be placed over a 3D model as it loads.

A studio image is a product image on a white background. Studio images often have associated tag names to identify various product positions. This may be for aesthetics when presenting the product or to match a 3D model's state to an image placeholder.

Additional tag types may exist but they're not needed for the implementation of this invention.

These records may be stored in a single table or multiple tables to accommodate a variety of ways in which they can be related.

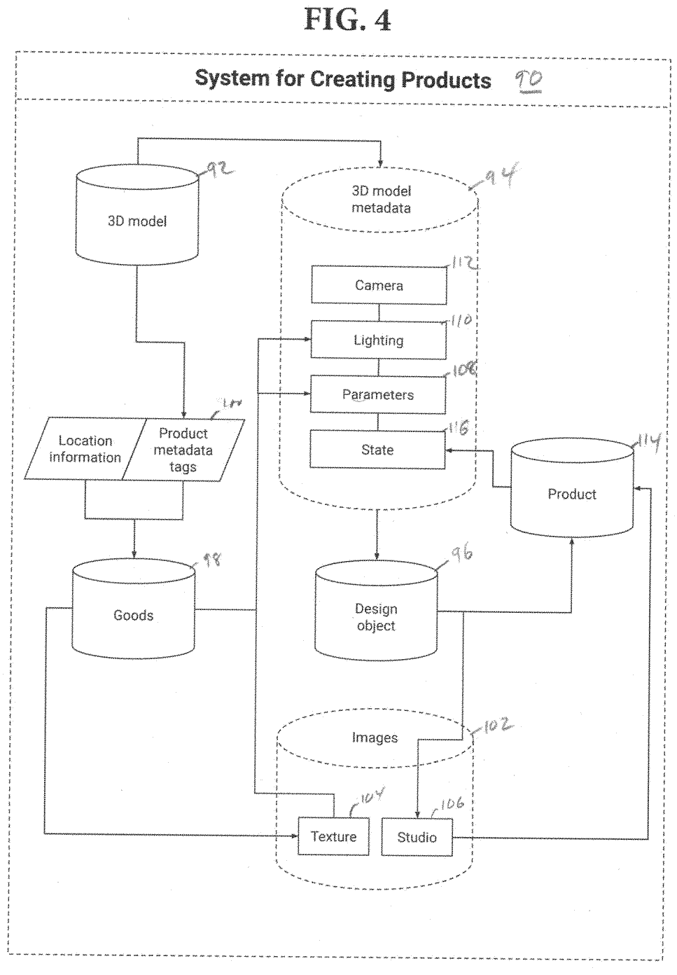

Now referring to FIG. 4, another embodiment of the present invention is directed to a system for creating products 90, wherein system 90 enables users to: create 3D models 92 and define initial 3D model metadata 94 for 3D models 92, define product category metadata tags for 3D models 92, design objects 96 created with association to 3D models 92 wherein goods 98 are retrieved based on product metadata tags 100 and location information 102, define goods for design object parameters 96, initiate design object's 3D model 92 using 3D model metadata 94 and goods images 102, including texture 104 and studio images 106, modify 3D model parameters 108, such as lighting 110 and camera 112 metadata, create a product 114 by storing state 116 and generating studio images 106 via a generate product images method.

System 90 may include an algorithm to generate products at runtime (i.e., during operation of the system) and, relying on the metadata systems described in this invention, the products generated may exist only for a single user session, although they may also be saved and used after an initial session. This generated product may link to a 3D model associated with a design object in a specific state or a page designed specifically for algorithmically created products. Based on user actions (like adding a generated product to a cart but not purchasing the product) this process may require an additional product record type specific to the efficient storage of a generated product's data.

In operation, a user creates products from a 3D model using goods and services by use of a design object. A design object record relates 3D models with goods and services based on selling requirements. These requirements may refer to location, limitation of parameters shown to the user, base price, grouping goods by supplier, etc. Without this intermediate step, a 3D model could load all applicable goods and services (that have a related parameter metadata record) via product categories but the volume of records could be problematically large for efficient user interaction.

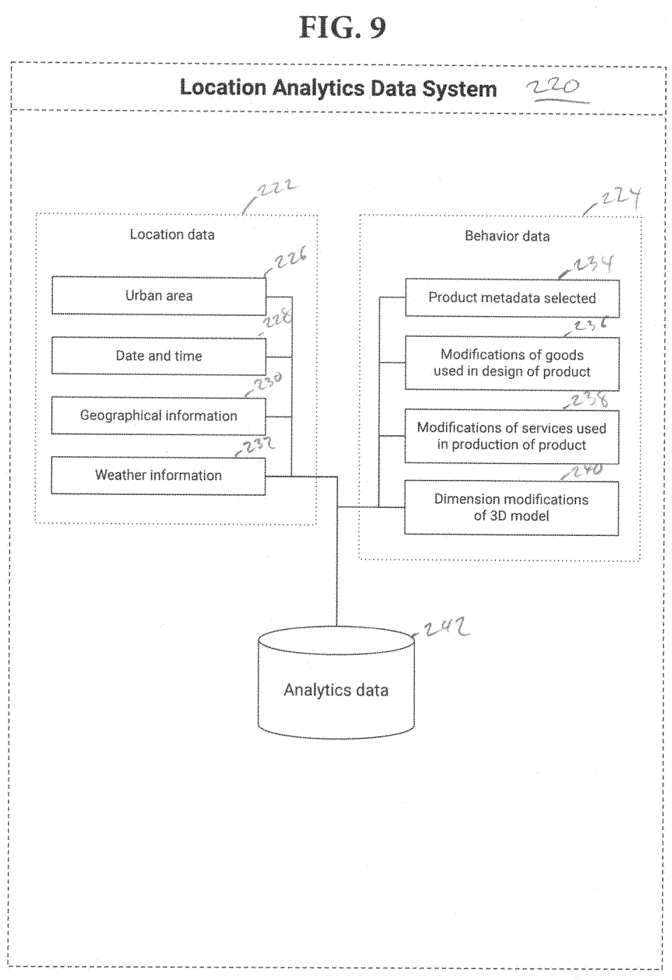

Products created via algorithm may use a script instead of a design object. Products may be created without a design object by substituting a script for the design object. This method may be favored by an algorithm that generates products as the created product(s) may not be saved in the database. This method uses data from the Location Analytics Data System (FIG. 9, infra.) to generate products through a script.

The process of initiating a 3D model for the creation of products requires the following:

A 3D model 92 with the required parameter, lighting, camera and state metadata records 108, 110, 112, 116 (respectively) to be initialized on a user device via client-side scripts and a product category record that associates the goods available for use in the 3D model. The association between the product category record and the available goods may be defined directly by the 3D model record or indirectly via a design object record.

A product category that associates the services required to produce the product generated by the 3D model. This association may be defined directly by the 3D model record or indirectly via a design object record.

Goods and services that relate to the associated product categories need an associated 3D model parameter record to be used in the given 3D model. This JSON data record provides the information needed to map the good or service to a 3D model's customization parameter(s) and includes a reference to the pricing object it relies on to price itself. It will often include a reference to a texture image associated with the good so that the good may be visualized on the 3D model. There may also be lighting metadata records associated with the good to ensure the best visualization of these textures.

With a 3D model initiated, a product may be created with the use of a design object that references a specific 3D model session with associated goods. This is useful for human input, creating products based on marketing requirements, and saving products to the database.

The use of a script for creating products at is useful for algorithms to create products based on behavior, location, etc. data.

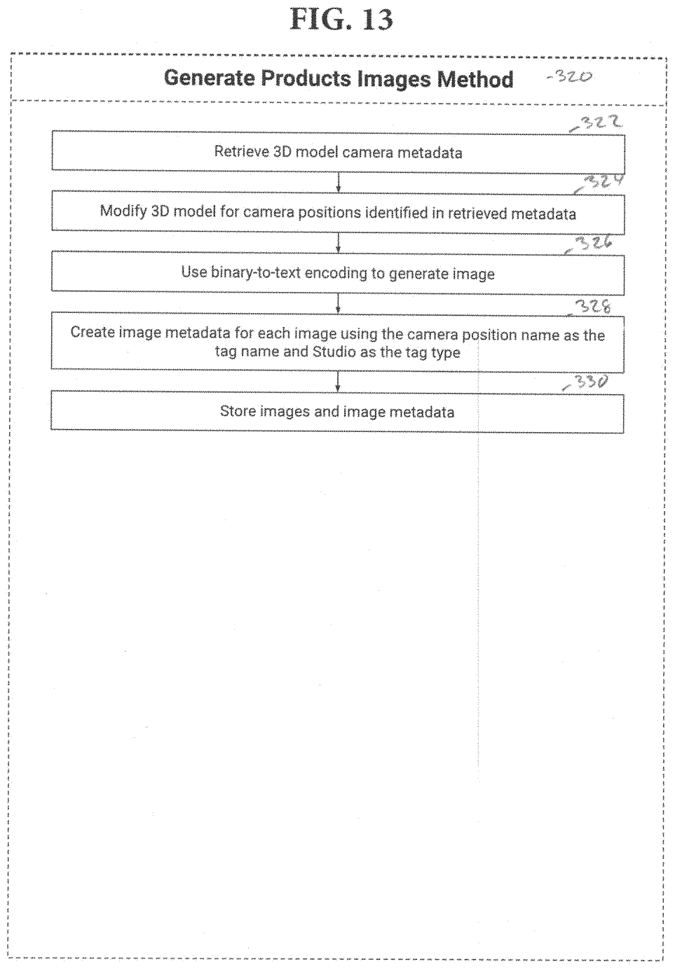

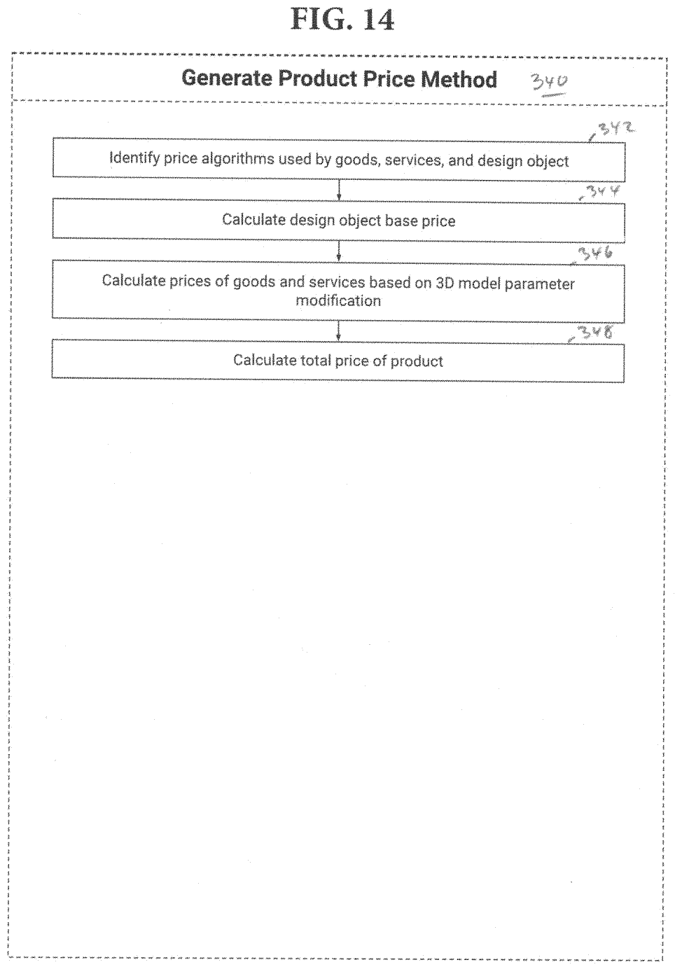

To show or save a product, Generate Product Price Method 340 (shown in FIG. 14) Generate Product Images Method 320 (shown in FIG. 13) and a Generate Product Texts Method may be utilized, as will be described, infra.

A database record for a product can be created by saving the product's state 3D model metadata and calculated price, and then associating this record with related product images, texts and design object or 3D model.

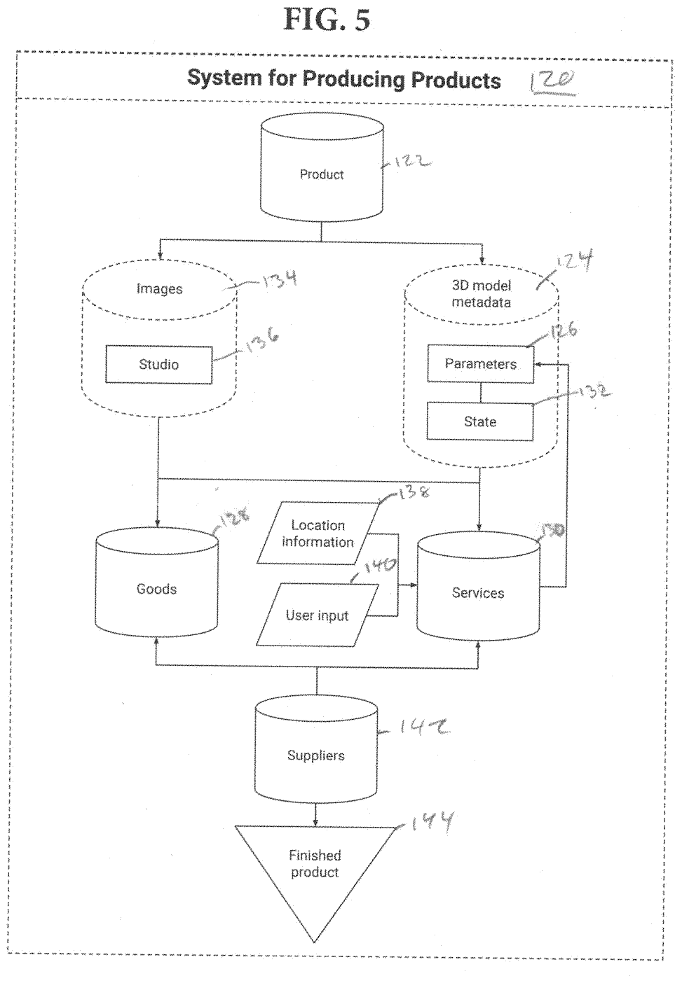

Another embodiment of the present invention as provided in FIG. 5 discloses a system 120 for producing products 122, wherein system 120 enables users to: prepare product 3D model metadata 124 according to 3D model parameter metadata 126 for goods 128 and services 130 and 3D model state metadata 132, generate product images 134, select services 130 using associated location information 138 and user input 140, transfer product images 134 and 3D model metadata 124 to goods and services suppliers 142 that further enable suppliers to produce finished product 144.

State 3D model metadata 132 identifies the goods and services used in the product and provides required information to suppliers for production of the product.

Studio images 136 of the product may be shared with suppliers to confirm how the product should look.

Suppliers 142 may be specified based on a user input or script to facilitate directives concerning product production. For example, location information may be used to address logistical concerns, such as production time. The available metadata may also include feature product metadata that may be of interest or concern to the end user, such as sustainability of the materials used or other preferences.

Suppliers 142 then produce the finished product 144 based upon all of the metadata available to the end user, thereby resulting in a finished product 144 which is best suited for the end user's needs, preferences or requirements.

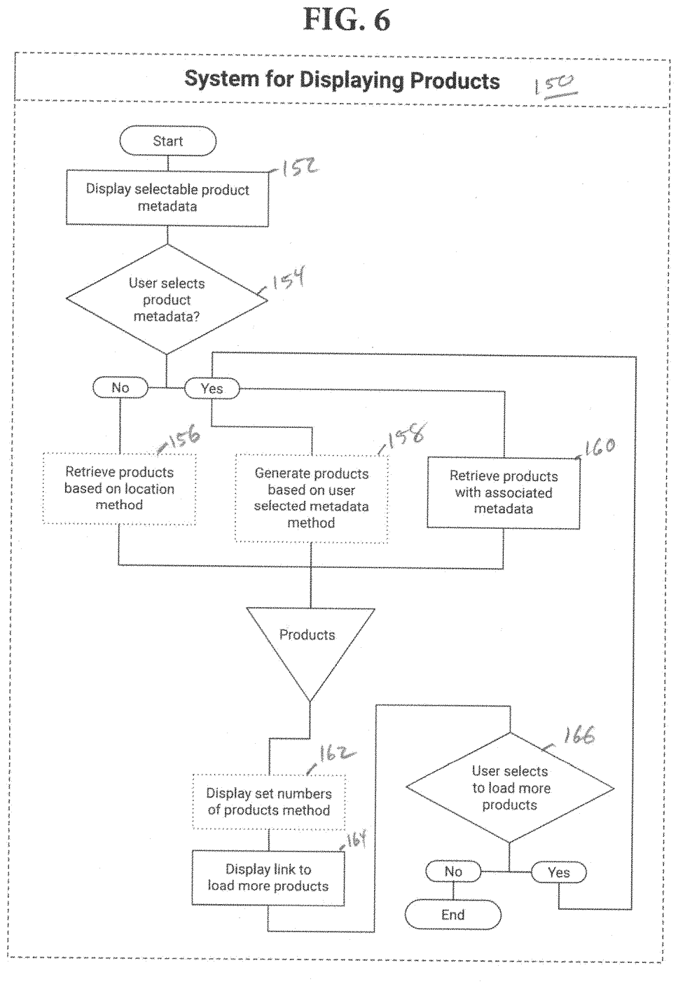

A still further embodiment of the present invention is illustrated by the flow chart of FIG. 6, which discloses a system for displaying products 150, wherein system 150 enables users to: display selectable product metadata 152, select product metadata 154, retrieve product based on location method 156, generate products based on user selected metadata method 158, retrieve products with associated metadata 160, display set number of products methods 162, and display link to load more products 164. The user also has the opportunity to select more products via an option 166.

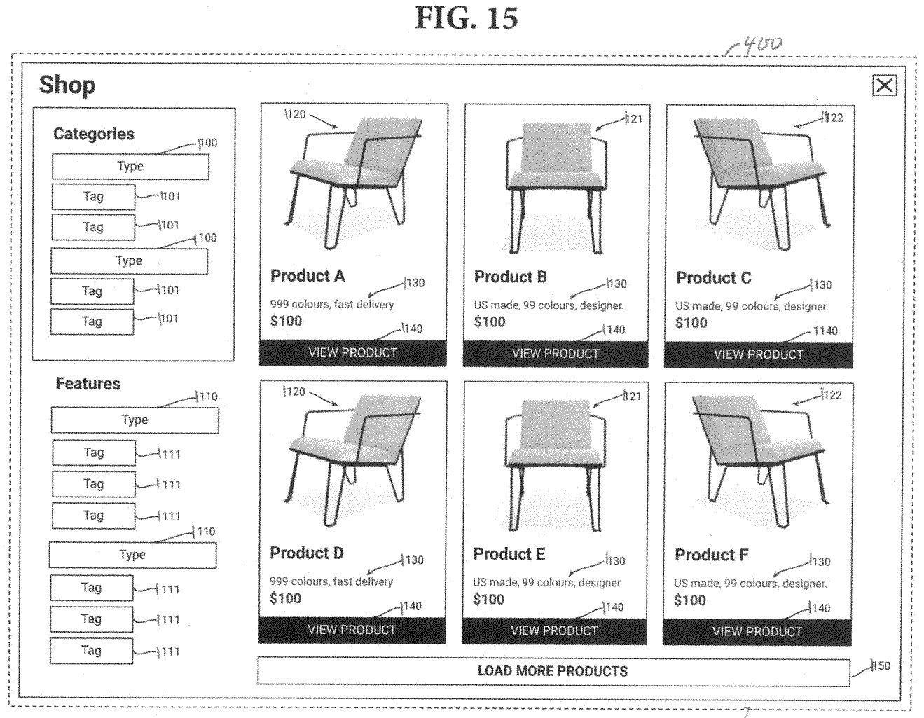

System 150 is used for the display of multiple products on a single page, includes user inputs 154 for the specification of desired product category(ies) and/or feature(s) metadata related (shown in use in FIG. 15, as Product Listing Page 400).

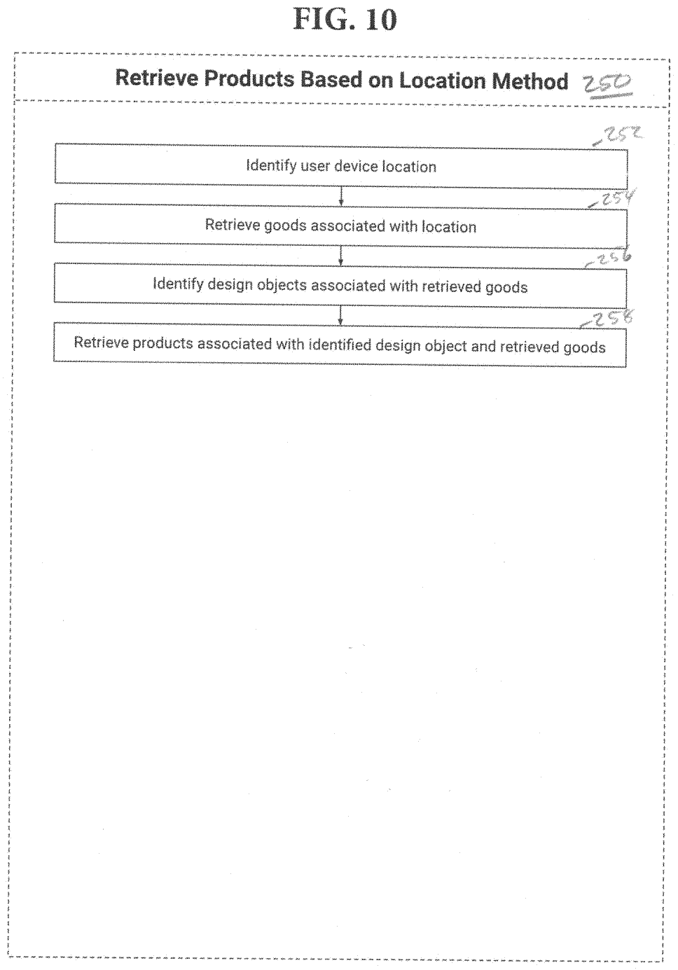

While the user is given the option of choosing how products are to be displayed, the default setting is preferably to show products based on location using the Retrieve Products Based on Location Method 250 (FIG. 10).

If the user selects the option of choosing products based on a product category or feature metadata, products are retrieved based on this specified data as per the Retrieve Products Based on Metadata Method 158 (FIG. 6). Products retrieved via this method have database records and as such, have associated design objects.

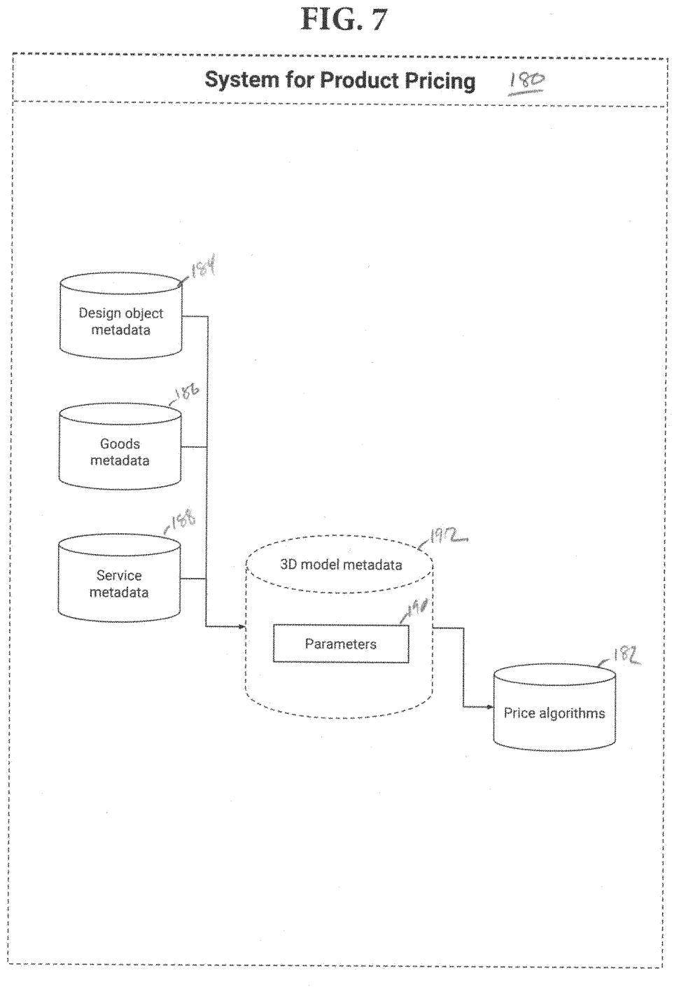

Another aspect of the present invention is illustrated in FIG. 7, which shows a system for product pricing 180, wherein system 180 calculates prices using price algorithms 182 that are developed based on design object metadata 184, goods metadata 186 and service metadata 188 integrated into parameters 190 within 3D model metadata 192.

System 180 relies on pricing objects that are database records and store mathematical expressions with variable names in JSON format (for example: 0.5*{{variable name}}).

Utilizing a specific, consistent, syntax for variable names enables the frontend to create a pricing function with the variable names as parameters.

The purpose of the pricing object is to deliver a mathematical expression and where the value of the named variables fits in that expression.

A base price may be set through a design object or script.

Goods/Services parameter 3D model metadata includes a reference to the pricing object it relies on to price itself and which parameter values are to be used as variables ({{variable name}}) in the pricing object's expression.

As products are 3D models in a specified state, whenever a 3D model's state is changed, the new state (product) is automatically priced based on a base price plus the prices of goods/services (though their parameter 3D model metadata).

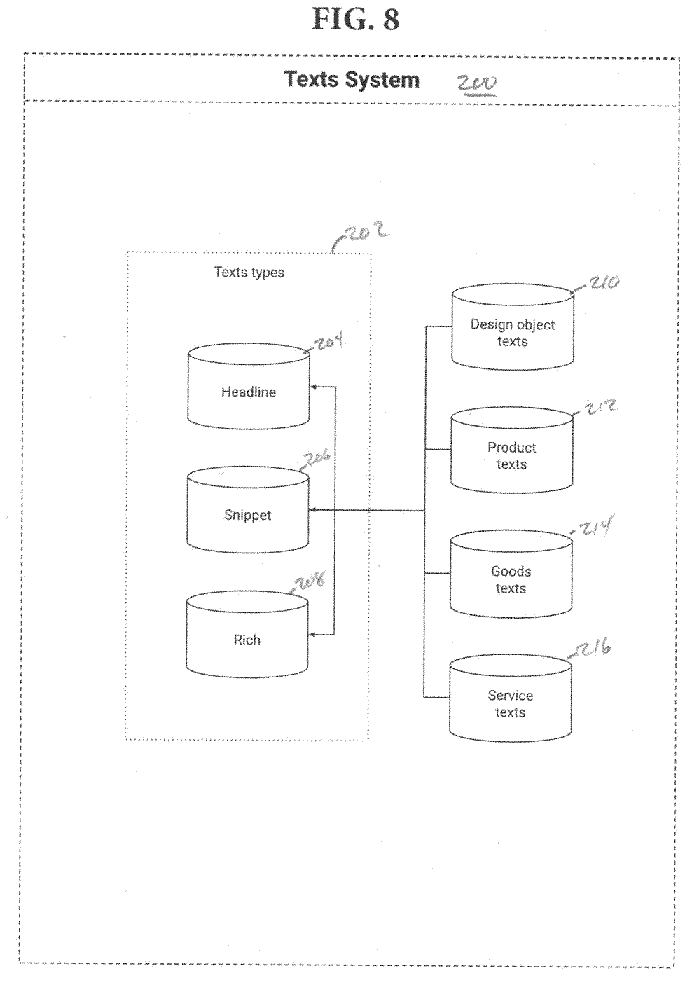

A still further aspect of the present invention is shown in FIG. 8, which shows a texts system 200, wherein system 200 develops texts types 202 such as a headline 204, which is a limited body of text (preferably less than 250 characters maximum) used as an introduction on product pages, short descriptions (“snippets”) 206 used on listing pages and open-ended rich text content 208 (such as text formatting, HTML markup, images, links, etc.) by compiling design object texts 210, product texts 212, goods texts 214 and service texts 216. Text content would also include specific information related to each good/service.

The texts may also be associated with features of the Product Metadata System 16.

System 200 enables the display of texts based on user selected feature product metadata. Products, goods/services, and design objects can have one or unlimited texts records.

The purpose of this relates mostly to headline and snippets texts types 204, 206, respectively, and enables varying texts to be written that address feature product metadata.

If a user selects a feature (product metadata) and the associated products don't have specific texts that relate to those features, the application may retrieve related design object, goods/services texts that relate to the selected feature.

System 200 also enables texts for algorithmically created product instances through their associated goods/services.

Yet another aspect of the present invention is shown in FIG. 9, which shows a location analytics data system 220, wherein system 220 includes location data 222 and behavior data 224. Location data 222 include data from urban area 226, data and time data 228, geographical information 230 and weather information 232. Behavior data 224 include selected product metadata 234, modifications of goods used in design of product 236, modifications of services used in production of product 238 and, dimension modifications of 3D model 240. Location data 222 and behavior data 224 together produce analytics data 242.

In another embodiment of the present invention illustrated in FIG. 10, a method to retrieve products based on location 250 is disclosed. Method 250 comprises the steps of: identifying user device location 252; retrieving goods associated with that location 254; identifying design objects associated with the retrieved goods 256; and retrieving products associated with the identified design object and the retrieved goods 258.

There are several ways to identify a location for a starting point for the selection process, including identifying the location associated with the IP address of the user's device, prompting the user to select a location (either from a drop-down menu or some other known fashion), or any other well known method for accessing location data for a user or device.

Once the location is identified, goods associated with the location may be retrieved 254. Goods and services are available in locations based on their supplier(s) and locations associated with the supplier(s).

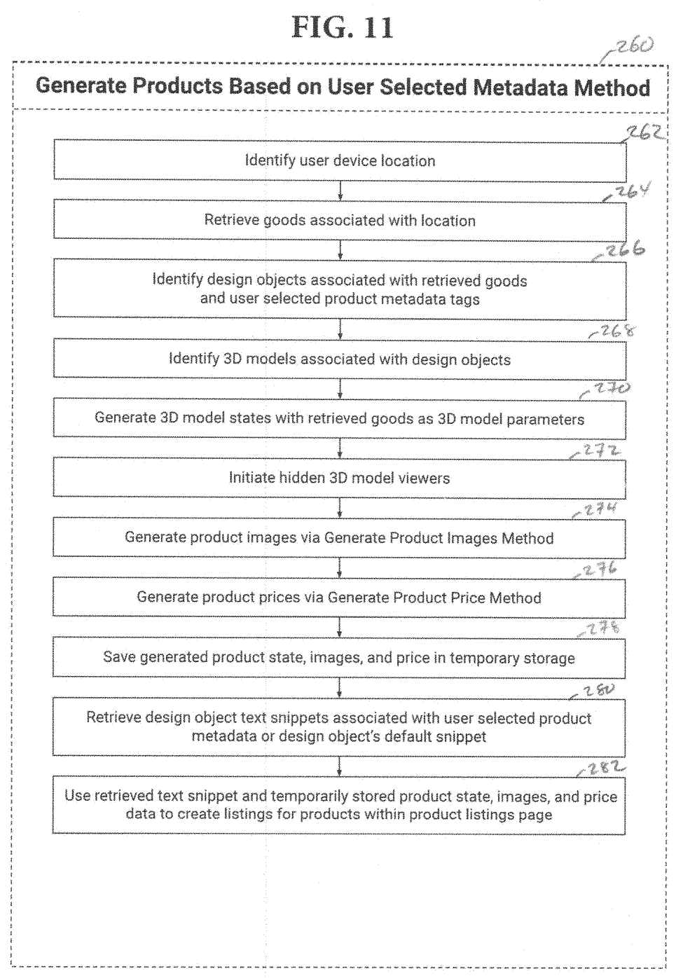

A further embodiment of the present invention is illustrated in FIG. 11, which shows a method to generate products based on user selected metadata 260, wherein method 260 comprises the steps of: identifying user device location 262; retrieving goods associated with the location 264, identifying design objects associated with retrieved goods and user selected product metadata tags 266; identifying 3D models associated with design objects 268; generating 3D model states with retrieved goods as 3D model parameters 270; initiating hidden 3D model viewers 272; generating product images via generate product images method 274; generating product prices via generate product price method 276; saving generated product state, images, and price in temporary storage 278; retrieving design object text snippets associated with user selected product metadata or design object's default snippet 280; and using retrieved text snippet and temporarily stored product state, images, and price data to create listings for products within product listings page 282.

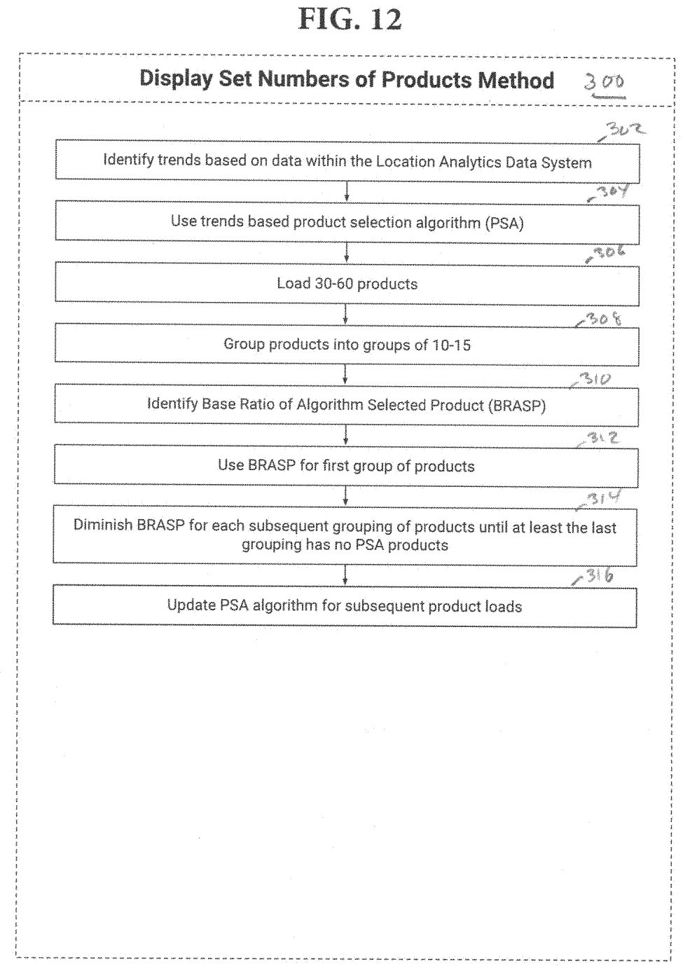

In another embodiment of the present invention illustrated in FIG. 12, a method to display set numbers of products 300 is shown. Method 300 comprises the steps of: identifying trends based on data within the location analytics data system 302; using trends based product selection algorithm 304; loading at least 30 products 306; grouping products into groups of at least 10 308; identifying base ratio of algorithm selected product 310; using base ratio of algorithm selected product for first group of products 312; diminishing base ratio of algorithm selected product for each subsequent grouping of products until at least the last grouping has no product selection algorithm products 314; and updating product selection algorithm for subsequent product loads 316.

A still further aspect of the present invention is illustrated in FIG. 13, which shows a method to generate products images 320. Method 320 comprises the steps of: retrieving 3D model metadata 322; modifying 3D model for camera positions identified in retrieved metadata 324; using binary-to-text encoding to generate an image 326; creating image metadata for each image using the camera position name as the tag name and studio as the tag type 328; and storing images and image metadata 330.

Yet another aspect of the present invention is illustrated in FIG. 14, which shows a method to generate product prices 340, wherein method 340 comprises the steps of: identifying price algorithms used by goods, services, and design object 342; calculating design object base price 344; calculating prices of goods and services based on 3D model parameter modification 346; calculating the total price of the product 348.

Now referring to FIG. 15, another embodiment of the present invention utilizes a product listing page 400, that further visualizes selectable product metadata tags based on category name tag types 1100, selectable product metadata tags based on tag names within a category name tag type (as provided in product metadata tag system) 1101, selectable product metadata tags based on feature name tag types 1110, selectable product metadata tags based on tag names within a feature name tag type (as provided in product metadata tag system 10) 1111, generated product image with studio image metadata tag type and specified tag name for left column display (as provided in image metadata tag system 70) 1120, generated product image with studio image metadata tag type and specified tag name for center column display (as provided in image metadata tag system 70) 1121, generated product image with studio image metadata tag type and specified tag name for right column display (as provided in image metadata tag system 70) 1122, associated snippet texts type for product (as provided in texts system 200 and retrieve texts method) 1130, link to individual product page 1140, and link to load more products (as provided in display of multiple products system) 1150.

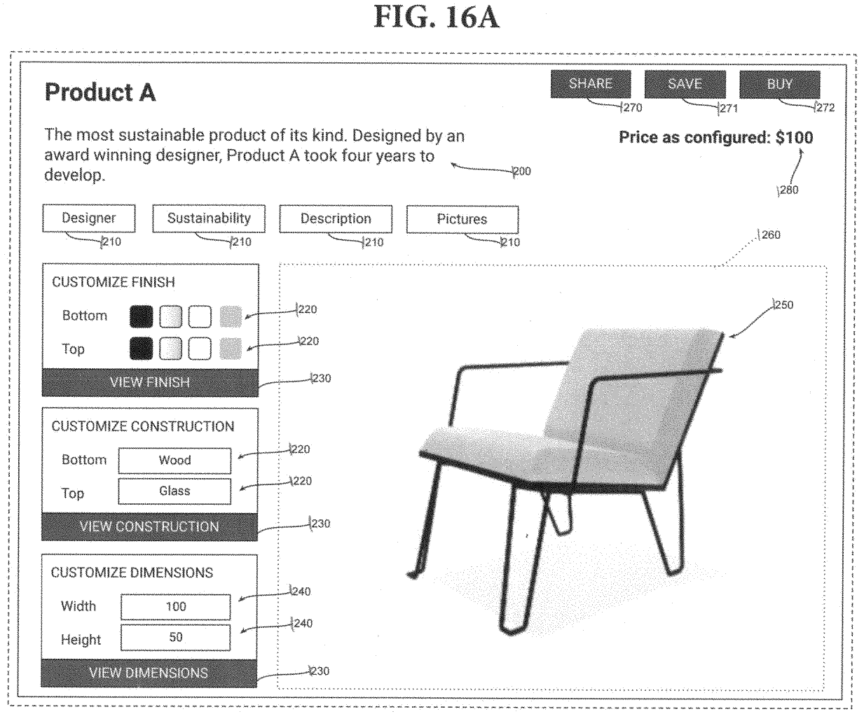

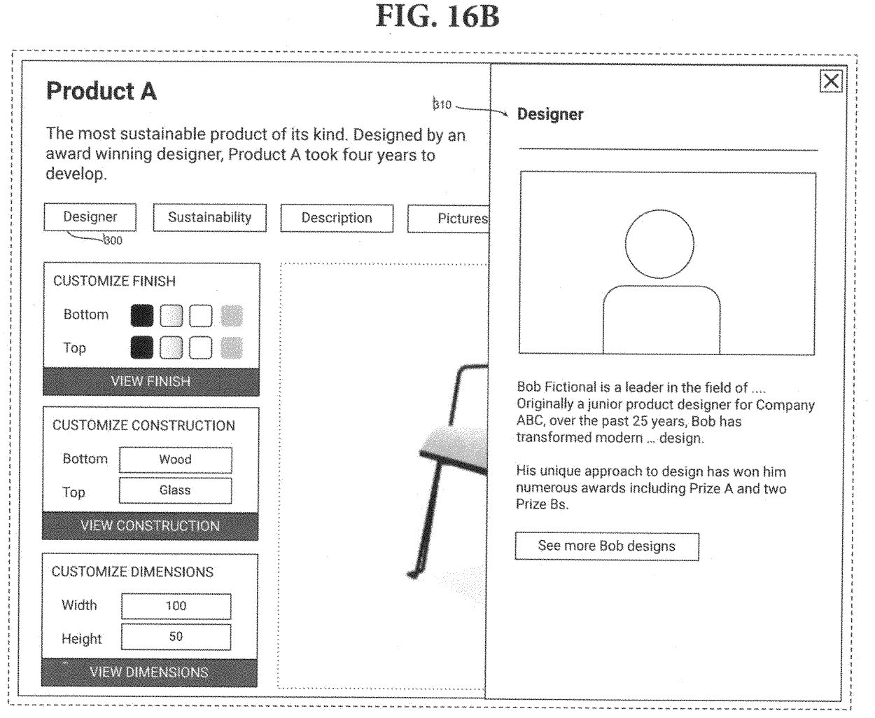

Now turning to FIG. 16A, another embodiment of the present invention discloses an individual product page that further visualizes associated headline texts type 204 for product (as provided in texts system 200 and retrieve texts method) 1200, links to associated rich texts type 208 for product (as provided in texts system 200 and retrieve texts method) 1210, modifiable attributes that take goods as parameters (as provided in system for creating products 90) 1220, link to modify the 3D model to show a visual representation of the parameters 1230, modifiable attributes based on 3D model metadata 1240, 3D model of product 1250, 3D viewer element 1260, link to share product 1270, link to save product 1271, link to buy product 1272, and product price (as provided in generate product price method 340) 1280. Similarly, FIG. 16B shows an individual product page with an overlay showing selected rich text content, that further visualizes links to associated rich texts type for product (as provided in texts system 200 and retrieve texts method) 1300 and an overlay element showing rich texts content 1310.

In a preferred embodiment of the present invention, an e-commerce platform for the selling of goods and services through made-to-order products generated by three-dimensional models comprising: (i) a product metadata tag system, wherein the said product metadata tag system further includes design object metadata, goods metadata, product metadata, service metadata, texts metadata and image metadata, wherein, the said product metadata tag system is used to classify products and to design objects, goods, products, services, texts and images, wherein, tag types are based on product features or categories and tag names and tag types of said product metadata tag system are related to how a consumer searches for products and is capable to have infinite tag names and infinite tag types wherein, each tag name must have at least one associated tag type;

(ii) a 3D model metadata system, wherein the said 3D model metadata system further includes metadata related to camera, lighting, parameters and specific state of a model, wherein 3D model metadata system is applicable to design objects, goods, products, and services and particularly used to store data related to 3D models and every 3D model has a default camera, lighting, parameter, and state metadata and design objects supplement or override this data and have a default state metadata wherein, products are a design object in a specific state and goods and services supplement this data to accommodate themselves; (iii) image metadata tag system, wherein the said image metadata tag system includes image metadata tags that are further classified as texture and studio and the said image metadata tag system is used to classify images wherein specific classifications are used in specific places and the said image metadata tag system is capable of infinite tag names however, each tag must belong to a tag type; (iv) a system for creating products, wherein the said system for creating products enables users to: create 3D models and define its initial 3D model metadata; define product category metadata tags for 3D model; design object created with association to 3D model wherein goods are retrieved based on product metadata tags and location information; define goods for design object parameters; initiate design object's 3D model using 3D model metadata and goods texture images; modify 3D model parameters, create a product by storing state and generating studio images; (v) a system for producing products, wherein the said system for producing products enables users to: prepare product 3D model state metadata according to 3D model parameter metadata for goods and services; generate product images; select services using associated location information and user input; transfer product images and 3D model metadata to goods and services suppliers that further enable suppliers to produce product; (vi) a system for displaying products, wherein the said system for displaying products enables users to: display selectable product metadata; select product metadata; retrieve product based on location; generate products based on user selected metadata; retrieve products with associated metadata; display set number of products methods; display link to load more products; (vii) a system for product pricing, wherein the said system for product pricing calculates prices using price algorithms that are developed based on design object metadata, goods metadata and service metadata integrated in the 3D model metadata; (viii) a texts system, wherein the said texts system develops text types such as headline which is a sentence used as an introduction on product pages, short descriptions for listing pages and open ended rich text content by compiling the design object texts, product texts, goods texts and service texts; and (ix) a location analytics data system, wherein the said location analytics data system include location data and behavior data, wherein the said location data further include data from urban area, data and time, geographical information and weather information, wherein the said behavior data further include selected product metadata, modifications of goods used in design of product, modifications of services used in production of product and, dimension modifications of 3D model.

The methods disclosed herein may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

The present invention is described above with reference to a preferred embodiment. However, those skilled in the art will recognize that changes and modifications may be made in the described embodiment without departing from the nature and scope of the present invention. To the extent that such modifications and variations do not depart from the spirit of the invention, they are intended to be included within the scope thereof.

In the preceding Detailed Description, reference was made to the accompanying drawings, which form a part of this disclosure, and in which are shown illustrative specific embodiments of the invention. In this regard, directional terminology, such as “top”, “bottom”, “left”, “right”, “front”, “back”, etc., is used with reference to the orientation of the Figure(s) with which such terms are used. Because components of embodiments can be positioned in a number of different orientations, the directional terminology is used for purposes of ease of understanding and illustration only and is not to be considered limiting.

Additionally, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for selling customized goods and/or services, the method comprising:
receiving user input for a desired type of good and/or service to be customized;
accessing a first database to retrieve a 3D CAD model of said desired type, said database also providing a list of attributes of said desired type, said attributes being usable in the construction of a finished good and/or service;
selecting one or more attributes from said list of attributes;
accessing a second database to retrieve goods and/or services of said desired type with characteristics linked to said one or more selected attributes;
loading hidden instance of 3D CAD models with goods and/or services as inputs;
mapping goods and/or services to product inputs;
generating instances of a customized product and 3D images of the product being customized in response to the selection of one or more attributes; and
presenting generated 3D depiction of a customized good and/or service selected in conformity with the selected attributes thereof.

2. The method of claim 1, further comprising the further step of:
receiving a closing signal from the user selected from at least one of:
ending the customization process;
continuing the customization process; and
sending a selection signal to initiate construction of a finished product having the selected attributes.

3. The method of claim 1, wherein said list of attributes includes at least one of: color, size, texture, fabric, sustainability, and geographic location.
